(19) United States
(12) Patent Application Publication
(10) Pub. No.: US 2007/0269150 A1
(43) Pub. Date: Nov. 22, 2007

(54) Bearing arrangement for an axle mount of an articulated vehicle

(75) Inventor: Werner Guilford, Hulmeville, PA (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 11/801,600

(22) Filed: May 10, 2007

Related U.S. Application Data
(60) Provisional application No. 60/799,553, filed on May 10, 2006.

(51) Int. Cl. F16C 23/04; F16C 25/04; F16C 23/08

(52) U.S. Cl. 384/208

(57) ABSTRACT

A bearing arrangement includes a hinge pin and a ring rotatably mounted on an outer surface of the hinge pin. The hinge pin has a spherical convex surface on which a spherical concave surface of the ring can ride. In a bearing having a pin and a ring that is rotatable about an outer surface of the pin, the pin has a spherical convex surface that extends around an outer surface of the pin, and the ring has a corresponding spherical concave surface that extends around an inner surface of the ring. In a method for articulably mounting an axle to a vehicle, a ring having a spherical concave surface is assembled around a hinge pin having a spherical convex surface such that the spherical concave surface and the spherical convex surface engage. A split housing is assembled around the outer surfaces of the ring.

### CROSS REFERENCE TO RELATED APPLICATIONS

This application claims priority from U.S. Provisional Patent Application Ser. No. 60/799,553 entitled “Bearing Arrangement for the Axle Mount of an Articulated Truck” filed on May 10, 2006, the contents of which are incorporated herein by reference in their entirety.

### TECHNICAL FIELD

The present invention relates generally to bearing arrangements and, more particularly, to an improved spherical plain bearing.

### BACKGROUND OF THE INVENTION

Articulated vehicles are used in numerous types of heavy load applications (e.g., heavy duty applications such as construction equipment, off-road vehicles, cranes, over-the-road hauling equipment and other transport vehicles, logging vehicles, various types of tracked vehicles, and the like). In these vehicles, an axle is connected to a frame of the vehicle using a hinge pin. The hinge pin employs either a cylindrical sleeve bearing or a tapered bore spherical plain bearing. In a cylindrical sleeve bearing, an inner cylinder rotates on an axis within a sleeve that prevents or at least limits any radial displacement of the inner cylinder relative to the sleeve. In hinge pins that employ this type of bearing, any loading forces applied in the radial directions impose undue stress on the bearing parts as well as on the hinge pin itself. Particularly when the bearing is loaded from the side at skewed angles, stresses are imposed non-unifornly along the length of the bearing which often causes undue wear and premature failure. Even without side loading, any distortion or misalignment difficulties associated with the bearing further impose undue stresses that exacerbate the normal loading of the bearing, thereby contributing to the failure of the bearing.

Spherical plain bearings have been devised for the purpose of accommodating application, manufacturing, and distortion misalignment for which sleeve bearings are not capable of handling or are inadequate. These types of bearings have spherical contact surfaces which allow an inner ring to rotate with multiple degrees of freedom while positioned within an outer ring. This freedom of movement capability allows this type of bearing to self-align such that it automatically adjusts to any misalignment which may occur due to the application of loading forces, machining tolerances, welding distortions, or mounting deformations due to static and dynamic forces. Spherical plain bearings are particularly applicable where oscillating, tilting, or skewing movements must be permitted. Accordingly, an axle connected to the frame of an articulated vehicle using a hinge pin and spherical plain bearing arrangement can move over a wider range because the bearing allows for displacement of the axle (connected to the inner ring via the hinge pin) relative to the vehicle frame (connected to the outer ring). Machining imperfections, distortion, and misalignment difficulties that would normally generate considerable loading and cause the early failure of conventional cylindrical sleeve bearings can be accommodated with spherical plain bearings.

One drawback with respect to spherical plain bearings, however, lies in the difficulty in positioning of the inner ring within the outer ring during assembly. Because the outer ring has a spherical bearing surface it normally has a side aperture smaller than the size of the inner ring and therefore placement of the inner ring within the bearing cavity of the outer ring becomes a problem.

One manner of overcoming this drawback involves side loading the bearing. To side load the bearing, loading slots are formed on diametrically opposite sides of the outer ring. These slots are slightly wider than the inner ring, thereby allowing the bearing to be assembled by sliding the inner ring through the loading slots and rotating the inner ring to a position to allow the inner ring to be retained in the outer ring.

Side loading the bearing in this manner, however, makes the final bearing assembly sensitive to the orientation of the loading slots relative to the direction in which the load is applied. In particular, the loading slots are required to be oriented in a specified position to reduce the stress placed on the assembled bearing. Even when so arranged, stresses placed on the bearing during operation often cause the outer ring to shift. These stresses in conjunction with such a shift also cause the inner ring to move relative to the outer ring, thereby possibly enabling the inner ring to slide out of the outer ring. Also, lubricants used in the bearing can be lost through the loading slots.

Even in spherical plain bearings in which the inner and outer rings are positioned correctly, another drawback with respect to the use of these bearings in articulated vehicle applications involves the undesirable fracture of one or both of the bearing and the hinge pin due to the application of excessive loading forces and/or mismatching of the tapers in the bearing bore and on the hinge pin. Such loading forces and/or mismatching cause stresses to one or both the bearing and the hinge pin and often result in premature failure. Because the inner ring is in contact with the hinge pin through a frictionless contact surface but the hinge pin is fixed in both the axial and radial directions, any axial displacement of the inner ring in the direction of increased taper subjects the material of the hinge pin to stress. Furthermore, any attempt to displace the inner ring in a radial direction relative to the hinge pin, which can often occur in the movement of heavy equipment, subjects the hinge pin to significant amounts of stress. This stress, over time, will manifest in the form of degradation of the material of the hinge pin and eventually result in a breakdown of the bearing, the hinge pin, or both.

Optimal orientation of the inner ring relative to the outer ring facilitates the continued operation of the bearing. Furthermore, proper and continued lubrication also contributes to the most efficient operation of the bearing. By utilizing a less-than-optimal bearing configuration or improper lubrication, the bearing life may be shortened. Additionally, without the proper maintenance and operation of the bearing, the operation of the particular equipment in which the bearings are used may be compromised.

Based on the foregoing, what is needed is a bearing arrangement that overcomes the drawbacks associated with those of the prior art.

### SUMMARY OF THE INVENTION

In one aspect, the present invention is directed to a bearing arrangement that can be used to mount an axle to an articulated vehicle. The bearing arrangement includes a hinge pin and a ring rotatably mounted on an outer surface of the hinge pin. The hinge pin, which can be mounted to the axle, has a spherical convex surface on which a spherical concave surface of the ring, which can be mounted to a frame of the articulated vehicle, can ride. Because the two surfaces are complementary and three dimensional, multiple degrees of freedom of movement between the axle and the frame of the articulated vehicle can be realized.

In another aspect, the present invention is directed to a bearing having a pin and a ring that is rotatable about an outer surface of the pin. The pin has a spherical convex surface that extends around an outer surface of the pin, and the ring has a corresponding spherical concave surface that extends around an inner surface of the ring. When engaged the convex and concave surfaces are rotatable on each other to provide multiple degrees of freedom of movement of the ring relative to the pin.

In another aspect, the present invention is directed to a method for articulably mounting an axle to a vehicle. In this method, a ring having a spherical concave surface is assembled around a hinge pin having a spherical convex surface such that the spherical concave surface and the spherical convex surface engage. The ring may be two portions to facilitate the assembly thereof around the hinge pin. A split housing, which may also be two portions, is assembled around the outer surfaces of the ring. The split housing containing the ring and the hinge pin are connected to the frame of the vehicle.

One advantage of the present invention is that the fractures that are typical of the inner rings of spherical plain bearings due to the tapers of the inner rings are eliminated. By incorporating a spherical convex surface directly into the hinge pin instead of tapering the hinge pin, the applied loading forces can be applied normal (or nearly normal) to the surface of the hinge pin, thereby allowing the loading forces to be distributed more uniformly and efficiently over the surface of the pin. A more uniform and efficient distribution of the loading forces places less stress and wear on the material of the hinge pin, thereby enhancing the useful life of the hinge pin and the bearing arrangement in general.

Another advantage is that machining that is typically associated with pins or supporting structure on which the bearing arrangement is mounted is not required. In particular, when the mounting structure is a pin, undercuts, radii, and other various features that are used to form risers on the mounting structure to dissipate stress are unnecessary. By avoiding the use of stress-dissipating features, the mounting structure itself is subject to less machining, which in turn contributes to the overall strength of the mounting structure.

### BRIEF DESCRIPTION OF THE DRAWINGS

FIG. 1 is a front view of a bearing arrangement of the present invention.

FIG. 2 is a side view of the bearing arrangement of the present invention.

FIG. 3 is an exploded side view of the bearing of the present invention.

FIG. 4 is an exploded side view of an outer ring of the bearing fit into a split housing.

FIG. 5 is a perspective view of the outer ring of the bearing.

FIG. 6 is a front view of the outer ring of the bearing.

FIG. 7 is a side sectional view of the outer ring of the bearing.

### DETAILED DESCRIPTION OF THE PREFERRED EMBODIMENT

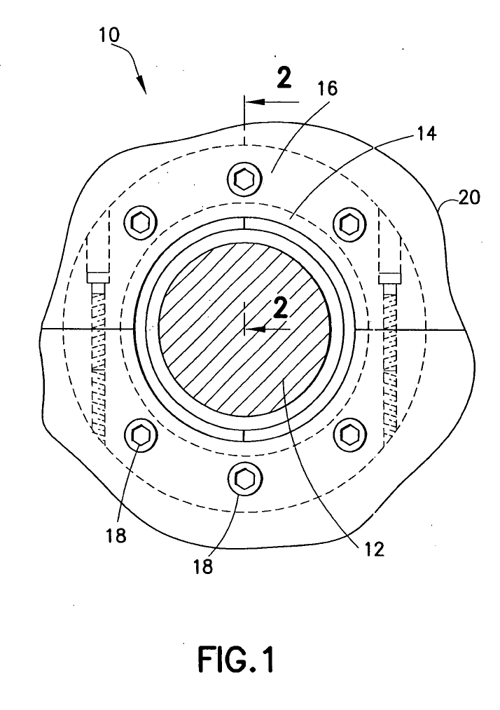

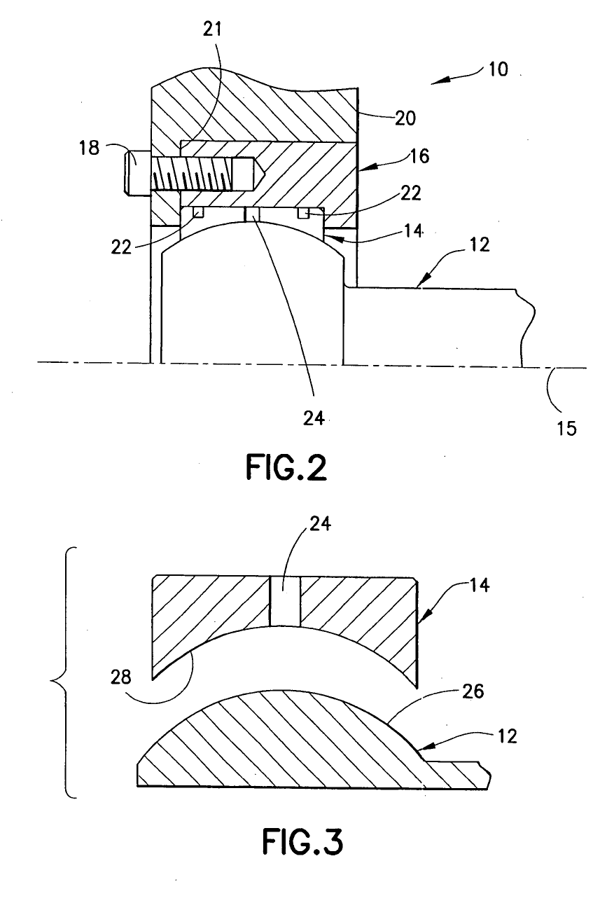

Referring to FIGS. 1 and 2, a bearing arrangement of the present invention is shown at 10. The bearing arrangement 10 includes a hinge pin 12 (FIG. 2) on which an outer ring 14 of a spherical plain bearing is rotatably mounted. The hinge pin 12 includes an axis 15 that extends longitudinally through the hinge pin. The outer ring 14 is captured or otherwise mounted within a split housing 16, which is in turn bolted (using bolts 18) or otherwise connected to a supporting structure such as a frame 20 or the like. A frame flange 21 is located on the frame 20 to facilitate the connection of the split housing 16 to the frame.

The frame 20 or other supporting structure may be the frame of a vehicle used in a heavy load application, such as an articulated vehicle. As used herein, the term “articulated vehicle” means a device having a frame and an axle, both being connected by a hinged joint, and one of the frame and the axle being movable relative to the other of the frame and the axle to steer the device. As used herein, the term “axle” means the entire portion of the vehicle on one side of the hinged joint. The hinged joint typically comprises an upper hinge pin and a coaxially aligned lower hinge pin. When the bearing arrangement 10 of the present invention is utilized in an articulated vehicle, at least the lower hinge pin of the hinged joint includes a bearing defined by the pin and the outer ring 14. The present invention is not limited with regard to articulated vehicles, however, as the bearing arrangement 10 may be used in conjunction with other devices or vehicles.

Referring to FIG. 2, the outer ring 14 captures and retains the hinge pin 12, which is connected to the axle of the articulated vehicle. The outer ring 14 has a spherical concave surface that engages a spherical convex surface of the hinge pin 12. Holes 22 and lubrication conduits 24 are drilled, bored, etched, or otherwise formed in an outer surface of the outer ring 14 that is opposite the spherical concave surface thereof and in contact with the split housing 16. The holes 22 extend partway into the outer surface of the outer ring 14, and the lubrication conduits 24 extend through the outer ring.

Referring to FIG. 3, the relationship of the hinge pin 12 and the outer ring 14 defines the bearing portion of the bearing arrangement. In a typical spherical plain bearing, the spherical concave surface of the outer ring engages and rotates on the spherical convex surface of an inner ring, which is held on the hinge pin on a functionless contact surface. In the bearing of the present invention, however, the hinge pin 12, which is defined as an elongated member, directly incorporates the spherical convex surface (hereinafter “the spherical convex surface 26”) around an outer circumferential portion of the cross section thereof. This surface is spherical convex to engage and provide a surface on which the spherical concave surface of the outer ring 14 (hereinafter “the spherical concave surface 28”) rotates.

The lubrication conduits 24 (only one shown) provide fluid communication from the outer surface of the outer ring 14 to the spherical concave surface 28 of the outer ring and to the spherical convex surface 26 of the hinge pin 12. Fluid communication through the lubrication conduits 24 allow for the application of a film of lubricant at the interface of the spherical convex surface 26 and the spherical concave surface 28.

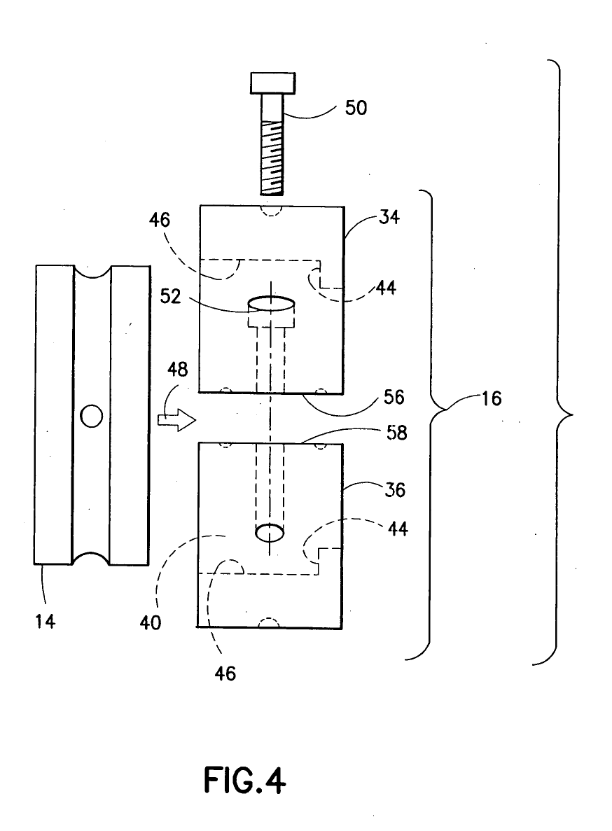

Referring to FIG. 4, the split housing 16 includes a first portion 34 and a second portion 36. The first portion 34 and the second portion 36, when mated together, define a cavity 40 in which the outer ring 14 resides. When the split housing 16 is assembled, a housing flange 44 extends around an inner wall 46 of the cavity 40. When the outer ring 14 is mounted onto the hinge pin and the split housing 16 is assembled to capture the outer ring, the housing flange 44 limits movement of the outer ring in the direction shown by an arrow 48 and prevents the outer ring from moving completely through the split housing. Because the hinge pin is held fast by the outer ring 14 to form the bearing of the present invention, the outer ring can move relative to the hinge pin to provide multiple degrees of freedom of movement.

The first portion 34 and the second portion 36 of the split housing 16 are held together using screws 50. Holes 52 extend into the outer surface of the first portion 34 of the split housing 16 and through a surface 56 of the first housing that mates with a corresponding surface 58 of the second portion 36. The holes 52 are threaded to accommodate the screw 50, thereby enabling the split housing 16 to be fastened together around the outer ring 14. The present invention is not limited to the use of screws, however, as other fasteners are within the scope of the present invention.

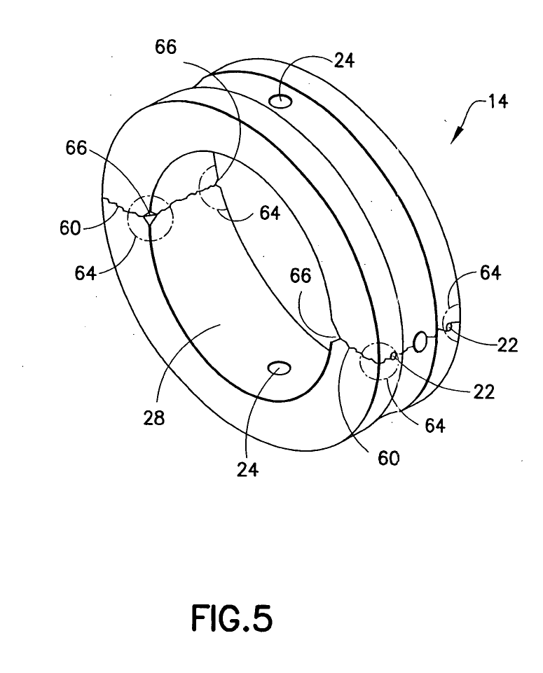

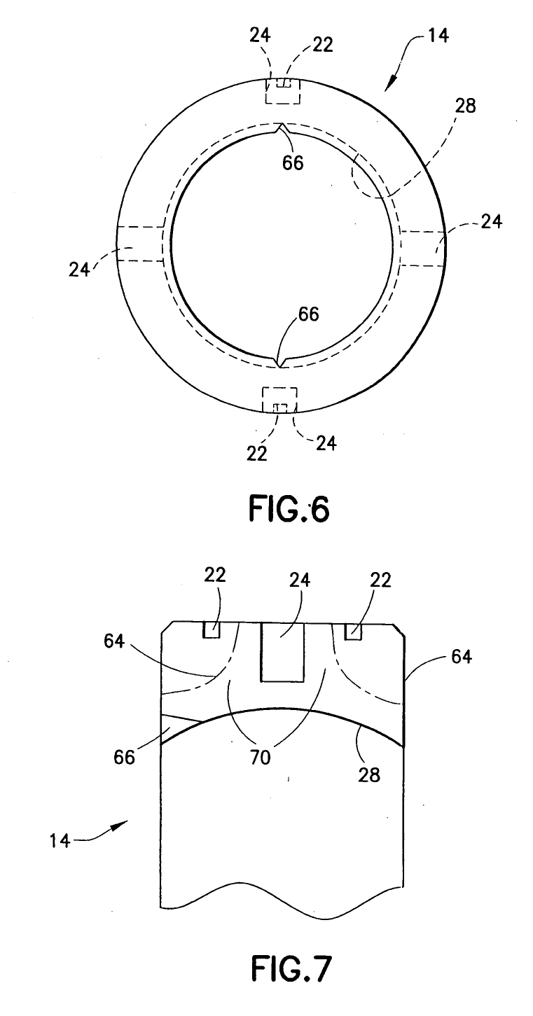

Referring to FIGS. 5 and 6, the outer ring 14 is double fractured to facilitate the removal thereof from the hinge pin once the split housing is removed. Two fractures 60 are formed on diametrically opposed sides of the outer ring 14 via the use of any suitable process, e.g., by the use of mechanical pressure in a V-block apparatus. The formation of each fracture 60 is facilitated by defining fracture zones 64, as is shown in FIG. 5. Each fracture zone 64 is positioned on the peripheral outer edges of the outer ring 14 and includes holes 22 that extend into the outer surface of the outer ring. As can be seen in FIGS. 5 and 6, the holes 22 are used to define the fracture zones 64. As can be seen in FIG. 5, the holes 22 are located proximate the peripheral outer edges of the outer ring 14. When the fractures are formed, they extend between the holes 22 on opposing sides of the outer ring 14.

One or more notches 66 are formed on each fracture 60. Each notch 66 functions to initiate the fracturing of the outer ring 14. Notches 66 are located on opposite sides (i.e., on the obverse and the reverse) of the outer ring 14 (two on each fracture 60). The present invention is not limited in this regard, however, and it should be understood that the outer ring 14 may be configured to have only one notch 66 on each fracture. The present invention is also not limited to the outer ring 14 being double fractured, however, as the outer ring may include only a single fracture.

The two lubrication conduits 24 are located opposite each other and intermediate the fractures 60. Additionally, two more lubrication conduits 24 may be located opposite each other on the fractures 60. As can be seen in FIG. 6, the lubrication conduits on the fractures 60 do not extend completely through the outer ring 14 to the spherical concave surface 28.

Referring now to FIG. 7, the holes 22 in the fracture zones 64 provide for areas 70 of reduced cross section. More specifically, the presence of the holes 22 reduces the amount of material in the outer ring 14. Because the amount of material in the outer ring 14 is reduced, surface-hardening processes have an effect that is more uniform throughout the outer ring. In particular, the holes 22, as well as the lubrication conduits 24, allow surface-hardening processes to penetrate into the material of the outer ring 14. Surface-hardening processes include, but are not limited to, the application of carbon or the like such that the carbon diffuses into the material of the outer ring 14. The notch 66 further reduces the cross sectional area 70 of the outer ring 14, thereby allowing for additional penetration of surface-hardening material into the material of the outer ring 14 from the spherical concave surface 28.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A bearing arrangement for mounting an axle to an articulated vehicle, said bearing arrangement comprising:
a hinge pin having a spherical convex surface; and
a ring having a spherical concave surface, said spherical concave surface being engaged with and rotatable on said spherical convex surface;
wherein said hinge pin is connected to said axle of said articulated vehicle and said ring is connected to a frame of said articulated vehicle.

2. The bearing arrangement of claim 1, wherein said ring includes two fractures.

3. The bearing arrangement of claim 2, wherein said fractures are formed in respective fracture zones position on peripheral outer edges of said ring.

4. The bearing arrangement of claim 3, wherein said fracture zones are formed by the removal of material from said ring.

5. The bearing arrangement of claim 1, further comprising at least one notch formed on each of said fractures.

6. The bearing arrangement of claim 1, wherein said ring includes at least one lubrication conduit.

7. The bearing arrangement of claim 6, wherein said at least one lubrication conduit extends from an outer surface of said ring to said spherical concave surface of said ring.

8. The bearing arrangement of claim 6, wherein said at least one lubrication conduit extends from an outer surface of said ring partway into said ring.

9. The bearing arrangement of claim 1, further comprising a housing in which said ring is mounted.

10. The bearing arrangement of claim 9, wherein said housing comprises a first portion and a second portion, said first portion and said second portion being capable of being held together using at least one fastener.

11. The bearing arrangement of claim 10, wherein said at least one fastener is a screw.

12. The bearing arrangement of claim 9, wherein said housing includes a flange extending around an inner wall of said housing.

13. The bearing arrangement of claim 9, wherein said ring is connected to said frame of said articulated vehicle through said housing.

14. The bearing arrangement of claim 13, wherein said frame is secured to said housing using a bolt.

15. A bearing, comprising:
a pin having a spherical convex surface extending about an outer circumferential portion of a cross section of said pin; and
a ring having a spherical concave surface extending about an inner circumferential portion of said ring;
wherein said spherical convex surface of said pin and said spherical concave surface of said ring are rotatable on each other to provide multiple degrees of freedom of movement of said ring relative to said pin.

16. The bearing of claim 15, wherein said ring comprises at least one lubrication conduit that extends from an outer surface of said ring to said spherical concave surface of said ring.

17. The bearing of claim 15, wherein said ring includes two fractures formed on diametrically opposite sides of said ring to facilitate the removal of said ring from said pin.

18. The bearing of claim 17, wherein said two fractures each extend through fracture zones formed in said ring.

19. The bearing of claim 18, wherein each of said fracture zones are formed by the reduction of cross sectional area of said ring and are effected by the removal of material from said ring.

20. The bearing of claim 18, wherein each of said fractures includes at least one notch that facilitates the fracturing of said ring.

21. A hinge pin for an articulated vehicle, said hinge pin comprising:
an elongated member having a spherical convex surface extending about an outer circumferential portion of a cross section of said member;
wherein said elongated member is attachable to an axle of said articulated vehicle; and
wherein said elongated member is configured to receive a corresponding spherical concave surface on said spherical convex surface.

22. A method for articulably mounting an axle to a vehicle, said method comprising the steps of:
providing a hinge pin having a spherical convex surface extending about an outer circumferential portion of a cross section of said hinge pin;
assembling a first portion of a ring having a spherical concave surface and a second portion of said ring having a spherical concave surface around said spherical convex surface of said hinge pin;
assembling a first portion of a split housing and a second portion of said split housing around the assembled first and second portions of said ring;
providing a frame;
attaching the assembled split housing with said ring and said hinge pin to said frame.

23. The method of claim 22, wherein said step of assembling said first portion of said split housing and said second portion of said split housing around said ring includes fastening said first portion of said split housing and said second portion of said split housing with screws.

24. The method of claim 22, wherein said step of attaching the assembled split housing to said frame includes causing a flanged bore in said frame to engage the assembled split housing.

25. The method of claim 24, further comprising the step of securing said assembled split housing to said frame with at least one bolt.
